(19) United States
(12) Patent Application Publication
(10) Pub. No.: US 2025/0299104 A1
(43) Pub. Date: Sep. 25, 2025

(54) APPARATUS AND METHODS FOR ADVANCED DIAGNOSTICS AND PROGNOSTICS OF SYSTEMS BASED ON PHYSICS INFORMED MACHINE LEARNING PROCESSES

(71) Applicant: PREDICTIVEIQ LLC, Parkland, FL (US)

(72) Inventors: Arash Alizadeh, Boston, MA (US); Esmaeil Dehdashti, Ithaca, NY (US); Juan F. Betts, Parkland, FL (US)

(73) Assignee: PREDICTIVEIQ LLC, Parkland, FL (US)

(21) Appl. No.: 19/087,005

(22) Filed: Mar. 21, 2025

Related U.S. Application Data
(60) Provisional application No. 63/568,906, filed on Mar. 22, 2024.

(51) Int. Cl. G06N 20/00

(52) U.S. Cl. CPC G06N 20/00

(57) ABSTRACT

This application relates to apparatus and methods for advanced diagnostics and prognostics of systems based on physics informed machine learning processes, as well as to the training of the physics informed machine learning processes. In some examples, a processor receives system data for a system. The processor inputs the system data to a physics-based model and, based on inputting the system data to the physics-based model, generates first output data characterizing physics-based relationships of the system. Further, the processor inputs the first output data to a machine learning model and, based on inputting the first output data to the machine learning model, generates second output data. The processor determines, based on the second output data, that the machine learning model is trained. The processor stores parameters characterizing the trained machine learning model in memory.

### CROSS-REFERENCE TO RELATED APPLICATIONS

This application claims the benefit of priority to U.S. Provisional Patent Application No. 63/568,906, filed on Mar. 22, 2024, the entire disclosure of which is expressly incorporated herein by reference to its entirety.

### FIELD OF THE INVENTION

The disclosure relates generally to system diagnosis and prognostication, and, more specifically, to machine learning based processes for system diagnosis and prognostication.

### BACKGROUND

Prognostics and Predictive Maintenance (PPMx) of systems is conventionally sensor driven and requires large data-centric processes. For example, systems, especially larger systems, may be associated with large amounts of data (e.g., various sensor data, input data, output data, reliability data, specification data, etc.). The PPMx processes must collect, store, aggregate, and process this system data, and then transmit the processed system data for presentation to decision makers for analyzation. As such, PPMx efforts are very expensive, as they require massive hardware (e.g., cloud/server infrastructure), software, and requirements that have produced, in many instances, limited successful results.

### SUMMARY

In some embodiments, a computing device includes at least one processor. The at least one processor is configured to receive system data for a system. The at least one processor is also configured to input the system data to a physics-based model and, based on inputting the system data to the physics-based model, generate first output data characterizing physics-based relationships of the system. Further, the at least one processor is configured to input the first output data to a machine learning model and, based on inputting the first output data to the machine learning model, generate second output data. The at least one processor is also configured to determine, based on the second output data, that the machine learning model is trained. The at least one processor is further configured to store parameters characterizing the trained machine learning model in a data repository.

In some embodiments, a method includes receiving system data for a system. The method also includes inputting the system data to a physics-based model and, based on inputting the system data to the physics-based model, generating first output data characterizing physics-based relationships of the system. Further, the method includes inputting the first output data to a machine learning model and, based on inputting the first output data to the machine learning model, generating second output data. The method also includes determining, based on the second output data, that the machine learning model is trained. The method further includes storing parameters characterizing the trained machine learning model in a data repository.

In some embodiments, a non-transitory computer readable medium has instructions stored thereon. The instructions, when executed by at least one processor, cause the at least one processor to perform operations. The operations include receiving system data for a system. The operations also include inputting the system data to a physics-based model and, based on inputting the system data to the physics-based model, generating first output data characterizing physics-based relationships of the system. Further, the operations include inputting the first output data to a machine learning model and, based on inputting the first output data to the machine learning model, generating second output data. The operations also include determining, based on the second output data, that the machine learning model is trained. The operations further include storing parameters characterizing the trained machine learning model in a data repository.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a machine learning based system diagnosis and prognostication (MLSDP) system in accordance with some embodiments;

FIG. 2 is a block diagram of an exemplary computing device in accordance with some embodiments;

FIG. 3 is a block diagram of a machine learning model training system in accordance with some embodiments;

FIG. 4 illustrates the training an exemplary machine learning model in accordance with some embodiments;

FIG. 5A illustrates traditional single task training;

FIG. 5B illustrates transfer learning in accordance with some embodiments; and

FIG. 6 illustrates a flowchart of an example machine learning model training method in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

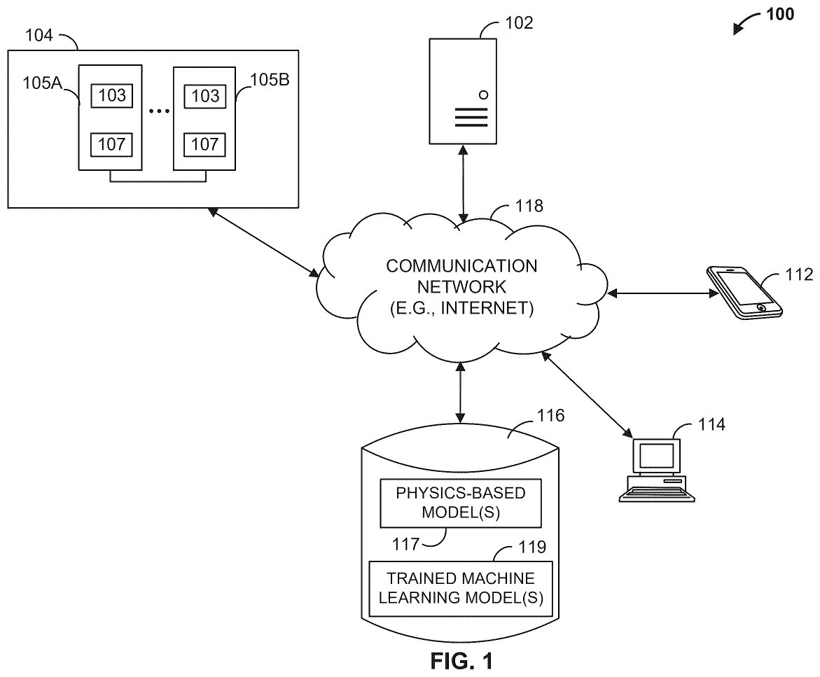

Turning to the drawings, FIG. 1 illustrates a block diagram of a machine learning based system diagnosis and prognostication (MLSDP) system 100 that includes MLSDP computing device 102, a system 104, a data repository 116, and multiple user computing devices 112, 114, all communicatively coupled over communication network 118.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

System 104 can be any system that takes in one or more inputs, and produces one or more outputs. Inputs and outputs may include, for example, data (e.g., signal data, control data, sensor data), material, fuel, mechanical force, or any other system input or output. As an example, system 104 may be an engine (e.g., a diesel or gas-powered engine). System 104 can include any number of subsystems 105A, 105B, which can operatively or communicatively be coupled to each other. For example, a first subsystem 105A of system 104 may receive one or more system inputs, and provide one or more first subsystem outputs. A second subsystem 105B of system 104 may receive one or more of the outputs of the first subsystem 105A, and provide one or more second subsystem outputs. Similarly, system 104 may include additional subsystems. System 104 may provide one or more outputs, such as one or more of the outputs of any the subsystems 105A, 105B.

Each of the subsystems 105A may include one or more sensors 107. Sensors 107 may measure or detect a physical phenomenon of the system 104. For example, a sensor 107 may detect temperature, speed, time, light, pressure, rates (e.g., acceleration rates, rotational rates), sound, altitude, fuel, gas (e.g., smoke) or any type of physical phenomenon capable of being detected or measured. Indeed, sensor 107 can be any type of sensor, and may generate a signal (e.g., data) that indicates a detection, or measurement, of the corresponding physical phenomenon. Each of the subsystems 105A, 105B may also include one or more processing units 103. Each processing unit 103 may include, for example, a processing device (e.g., a microcontroller, a processor, etc.), a transceiver, and a memory device. A processing unit 103 may be operable, for example, to receive data from, and transmit data to, communication network 118.

MLSDP computing device 102 and multiple user computing devices 112, 114 can each be any suitable computing device that includes any hardware or hardware and software combination for processing data. For example, each of MLSDP computing device 102 and multiple user computing devices 112, 114 can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

MLSDP computing device 102 can be, for example, a computer, a workstation, a laptop, a server such as a cloud-based server or an application server, or any other suitable computing device. Similarly, each of multiple user computing devices 112, 114 can be a laptop, a computer, a mobile device such as a cellular phone, a smart phone, a tablet, a personal assistant device, a voice assistant device, a digital assistant, or any other suitable device. Although FIG. 1 illustrates two user computing devices 112, 114, MLSDP system 100 can include any number of user computing devices 112, 114. Similarly, MLSDP system 100 can include any number of MLSDP computing devices 102, systems 104, and data repositories 116.

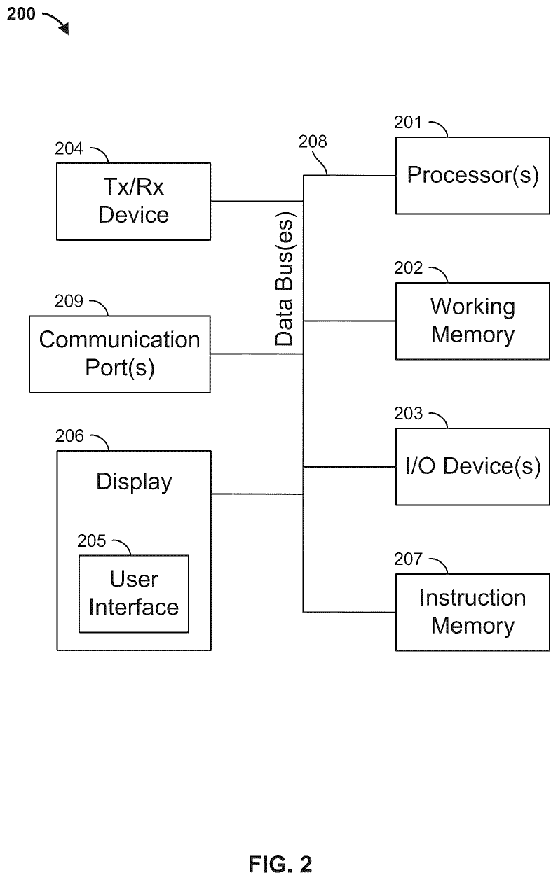

FIG. 2 illustrates an example of a MLSDP computing device 102. MLSDP computing device 102 includes one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory, an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of MLSDP computing device 102. Working memory 202 can be a random access memory (RAM) such as a static random access memory (SRAM) or dynamic random access memory (DRAM), or any other suitable memory.

Input/output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as data identifying and characterizing a physics-based model or a machine learning model.

Display 206 can display user interface 205. User interfaces 205 can enable user interaction with MLSDP computing device 102. For example, user interface 205 can be a user interface for an application (“App”) that allows a user to configure a physics model or machine learning model implemented by MLSDP computing device 102. In some examples, a user can interact with user interface 205 by engaging input/output devices 203. In some examples, display 206 can be a touchscreen, where user interface 205 is displayed on the touchscreen.

Transceiver 204 allows for communication with a network, such as communication network 118 of FIG. 1. For example, if communication network 118 is a cellular network, transceiver 204 is configured to allow communications with the cellular network. Processor(s) 201 is operable to receive data from, or send data to, a network, such as communication network 118, via transceiver 204.

Referring back to FIG. 1, MLSDP computing device 102 is operable to communicate with data repository 116 over communication network 118. For example, MLSDP computing device 102 can store data to, and read data from, data repository 116.

Data repository 116 can be a remote storage device, such as a cloud-based server, a memory device on another application server, a networked computer, or any other suitable remote storage. Although shown remote to MLSDP computing device 102, in some examples, data repository 116 can be a local storage device, such as a hard drive, a non-volatile memory, or a USB stick.

Further, as illustrated, data repository 116 stores data characterizing a physics-based model 117 and a trained machine learning model 119. MLSDP computing device 102 may obtain, and execute, one or more of physics-based models 117. Similarly, MLSDP computing device 102 may obtain, and execute, one or more of machine learning models 119.

The physics-based model 117 can be any model that mathematically characterizes a system, such as system 104. For instance, the physics-based model 117 may include one or more mathematical relationships between characteristics of the system, such as inputs, outputs, operations, specifications, historical data, and/or operating states of the system, among other examples. When system 104 is an engine, for example, the physics-based model 117 may characterize a relationship between lubrication conditions of contact interfaces based on oil viscosity, engine operating temperature, and the surface roughness of contacting bodies. The lubrication condition can identify a severity of wear on portions of the engine, such as on engine rings or cylinder bore surfaces.

In some examples, the physics-based model 117 may characterize a simulation (e.g., physics-based simulation) of the system. For example, a physics-based model 117 may include one or more reduced order models (ROMs). In some examples, a physics-based model 117 includes a multi-stage ROM that simulates a system, or one or more components of a system.

In some examples, a physics-based model 117 includes one or more surrogate models (SMs). Each SM may include an architecture that uses physics or mathematically informed approaches (simplified physics, finite element analysis, chemical processes, etc.) and data-driven statistical approaches (regression, multivariate statistics, Bayesian approaches, Uncertainty Quantification (UQ) methods, etc.) in a multi-stage structure.

For example, an SM may predict the output (O) of a system to received inputs (x). Each output can be, for example, a quantification of the present, past, or future states of the systems. For example, an SM may be generated to predict the remaining useful life of a component in an engine. In this example, the SM may predict present machine states and future machine states of the engine. The output of the SM (OsM) may be a prediction of output O. An error (E) (e.g., a system error) may be defined as O-OsM, in other words, the difference between an actual output O of a system and the predicted output of the system OsM.

Machine learning models 119 may identify and characterize one or more trained machine learning models that can diagnose and/or prognosticate system behavior, such as behavior of system 104. For example, machine learning models 119 may characterize a deep operator network (DeepOpNet), a deep learning model, a neural network (e.g., a convolutional neural network), or any other suitable artificial intelligence or machine learning based model (e.g., algorithm).

As described herein, MLSDP computing device 102 can employ physics-informed machine learning processes to diagnose and prognosticate operations of systems, such as system 104. To establish a physics-informed trained machine learning model, such as one characterized by the trained machine learning model 119, MLSDP computing device 102 may obtain physics-based model 117 from data repository 116, and may apply the physics-based model 115 to system data of system 104 to generate training data that is used to train the machine learning model. For example, MLSDP computing device 102 may receive at least portions of system data (e.g., sensor data from sensors 107, operational data, historical data, specification data, etc.) for system 104. The portions of system data may be received from system 104 and/or data repository 116 (e.g., system 104 may store the system data in data repository 104), for instance. Further, the portions of system data received correspond to the inputs of the physics-based model 117. MLSDP computing device 102 may execute the physics-based model 117, and may input the portions of the system data to the executed physics-based model 117. In response, the executed physics-based model 117 may generate output data characterizing the system 104.

MLSDP computing device 102 may use the output data generated by the executed physics-based model 117, as well as, in some examples, portions of the system data, to train a machine learning model to diagnose and/or prognosticate the status of systems. For example, rather than attempting to train the machine learning model based on all of the available system data for system 104, MLSDP computing device 102 generates a training data set based on the output data of the executed physics-based model 117 and, in some examples, portions of the system data. As a result, the size of the generated training data set (e.g., size in data bytes) is smaller (e.g., many times smaller) than the size of the available system data. Because the training data set is reduced, the machine learning model can be trained in less time and/or with less computational power.

To achieve even further time and/or computation savings, in some instances as described herein, one or more layers of the machine learning model may be held frozen (e.g., held constant) during the training. In other words, rather than allowing all of the layers of the machine learning model to “learn” during training, one or more of the of the layers are kept from modifying their parameters (e.g., weights), which may lead to faster convergence of the machine learning model.

Once trained, the MLSDP computing device 102 may store parameters (e.g., hyperparameters, weights, etc.) associated with the trained machine learning model 119 in data repository 116. Moreover, MLSDP computing device 102 can now establish (e.g., execute) the trained machine learning model based on the stored parameters.

For example, to diagnose and/or prognosticate the status of system 104, MLSDP computing device 102 may execute the trained machine learning model 119 based on the stored parameters. MLSDP computing device 102 may receive system data, such as sensor data from any of the sensors 107, for system 104, and may input the system data to the executed trained machine learning model. In response, the executed trained machine learning model may generate output data characterizing diagnostic and/or prognosticate information of the system 104. For instance, in the example of an engine, the output data may characterize total accumulated wear (TAW) of the engine.

In some instances, the MLSDP computing device 102 may transmit the output data over communication network 118 to one or more of the user computing devices 112, 114 for display. In some instances, the output data causes the user computing devices 112, 114 to execute an application that displays the output data. In some instances, a user of a user computing device 112, 114 may provide an input to the user computing device 112, 114. The input may characterize a selection or indication of an adjustment to the system 104. The user computing device 112, 114 may transmit adjustment data characterizing the adjustment to the system 104, causing the system 104 to make a corresponding adjustment to its operations.

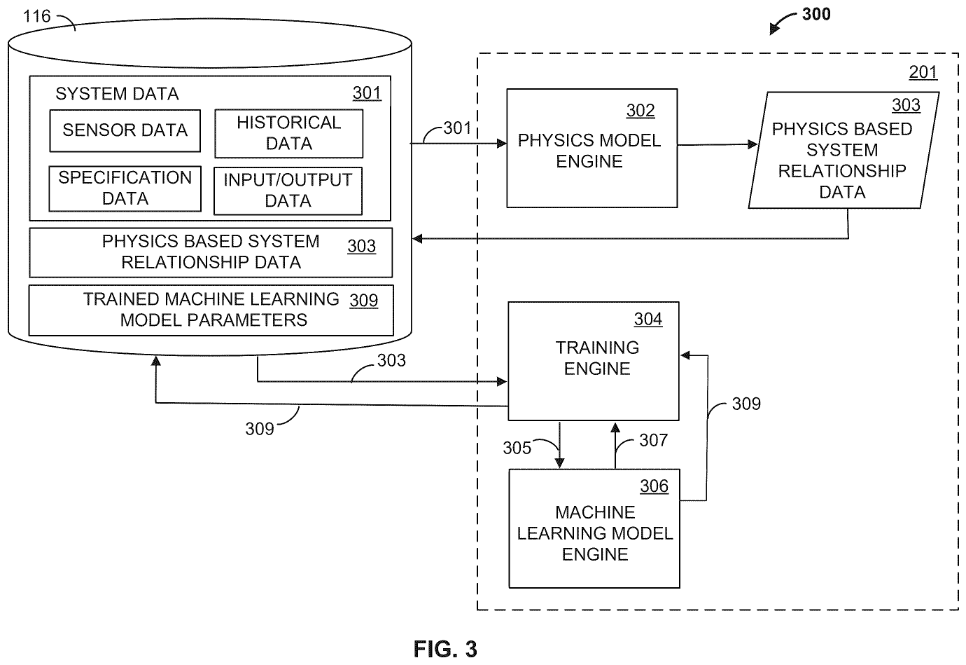

FIG. 3 illustrates a training system 300 that trains a machine learning model. As illustrated, the training system 300 includes a physics model engine 302, a training engine 304, a machine learning model engine 306, and a data repository 116. Each of the physics model engine 302, a training engine 304, and a machine learning model engine 306 can be implemented by one or more of: processors, FPGAs, ASICs, state machines, digital circuitry, or any other suitable circuitry. For instance, one or more of the functions of the physics model engine 302, training engine 304, and machine learning model engine 306 can be carried out by one or more processors executing instructions, such as one or more processors 201 of the MLSDP computing device 102.

As illustrated, data repository includes system data 301. The system data 301 may relate to a system, such as system 104. In this example, the system data 301 includes sensor data, historical data (e.g., data characterizing historical operations of the system), specification data, and input/output data. The physics model engine 302 may obtain at least portions of the system data 301, and apply a physics-based model, such as the physics-based model 117, to the system data 301 to generate physics-based system relationship data 303. The physics-based system relationship data 303 may identify relationships between inputs, outputs, operations, specifications, historical data, and/or operating states of the system, for instance. As an example, the physics model engine 302 may obtain system data 301 characterizing oil viscosity, engine operating temperature, and surface roughness of contacting bodies of an engine, and may input the obtained system data 301 to the physics-based model. In response, the physics-based model may generate physics-based system relationship data 303 characterizing a severity of wear on engine rings or cylinder bore surfaces. The physics model engine 302 may store the physics-based system relationship data 303 in data repository 116.

The training engine 304 may obtain the physics-based system relationship data 303 from the data repository 116, and may generate a training data set 305 based on the physics-based system relationship data 303. In some instances, the training engine 304 may obtain portions of the system data 301, in addition to the physics-based system relationship data 303, from the data repository 116, and may generate the training data set 305 based on the portions of the system data 301 and the physics-based system relationship data 303. The training engine 304 may then provide the training data set 305 to the machine learning model engine 306 for training a machine learning model.

For example, the machine learning model engine 306 may input the received training data set 305 to an untrained, or pre-trained, machine learning model, such as a DeepOpNet. In some examples, the machine learning model engine 306 freezes one or more layers of the machine learning model, and then inputs the received training data set 305 to the machine learning model with the frozen layers. Based on inputting the training data set 305 to the machine learning model, the machine learning model generates output data 307 characterizing system predictions or diagnostics. For instance, in the example of an engine, the output data 307 may characterize TAW.

The training engine 304 may receive the output data 307 from the machine learning model engine 306, and may determine whether the machine learning model is trained based on the output data. For example, the training engine 304 may compute one or more metric values, such as a loss function, to determine whether the machine learning model is trained. If the metric value satisfies (e.g., exceeds, is less than) the threshold, the training engine 304 determines that the machine learning model is trained. Otherwise, if the metric value does not satisfy the threshold, the training engine 304 continues training the machine learning model as described above.

When the training engine 304 determines that the machine learning model is trained, the training engine 304 obtains, from the machine learning model engine 306, parameters 309 characterizing the trained machine learning model. The training engine 304 may store the parameters 309 in the data repository 116.

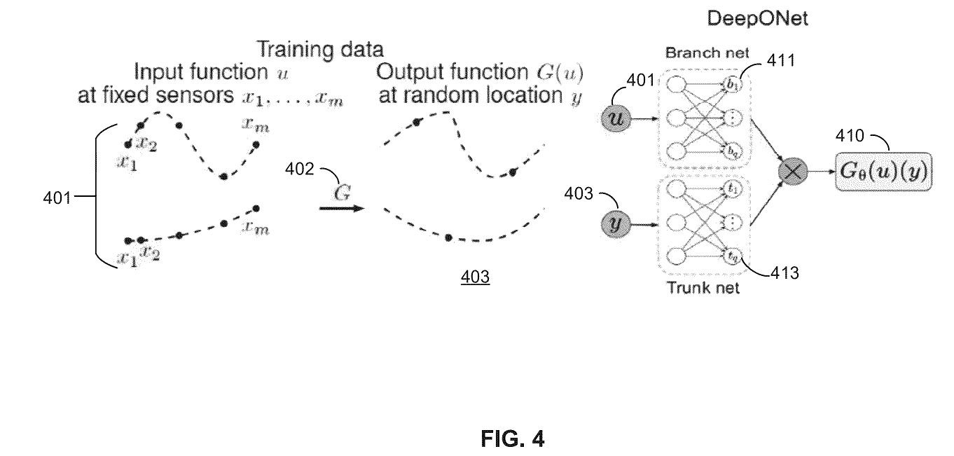

FIG. 4 illustrates the training of a DeepOpNet 410 based on exemplary system data 401 and physics-based system relationship data 403. As illustrated, the DeepOpNet 410 includes two deep neural networks including a branch net 411 and a trunk net 413. Each of the branch net 411 and trunk net 403 may include corresponding neural network layers. While the branch net 411 is trained with system data 401, the trunk net 413 is trained with physics-based system relationship data 403.

The system data 401 includes data samples from various input functions u at a fixed number of points (x₁, x₂, . . . . xₘ). The physics-based system relationship data 403 is a result of applying a physics-based model 402, G, to at least portions of the system data 401. For example, for a given input function u, the output of the physics-based model 402 G(u) at various points y is G(u) at each of the y locations. In some examples, the branch net 411 is trained with random samples of system data 401, and the trunk net 413 is trained with random samples of physics-based system relationship data 403. In some examples, one or more of the layers of the branch net 411, and/or one or more of the layers of the trunk net 413, are frozen during training. In some instances, all layers of the branch net 411, and all but the last layer of the trunk net 413, are frozen during training.

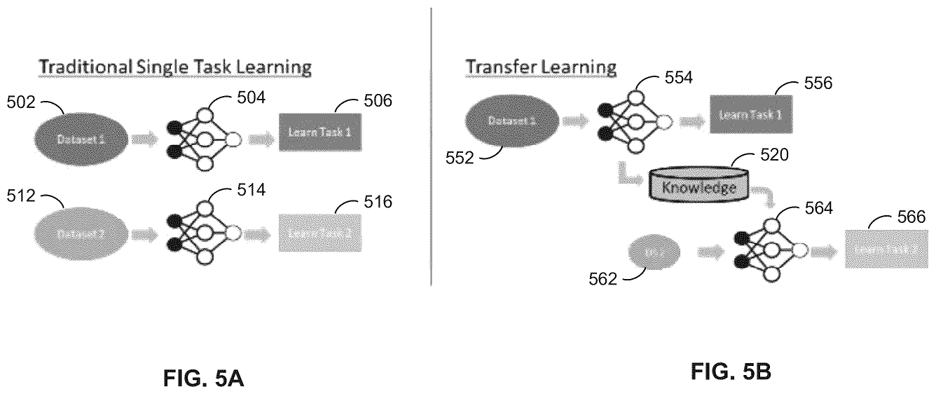

FIG. 5A illustrates a conventional single task learning implementation. Here, a first neural network 504 is trained with a first dataset 502 to allow the first neural network 504 to learn a first task 506. If a second task 516 is needed, then a second neural network 514 is trained with a second dataset 512 to allow the second neural network 514 to learn the second task 516.

In contrast, FIG. 5B illustrates a transfer learning process that can be employed with the training processes described herein to more efficiently (e.g., less time, cost, and/or computational power) allow a neural network to learn a task.

As illustrated, a first neural network 554 is trained based on a first dataset 552 that may include, for example, physics-based system relationship data, such as physics-based system relationship data 303, to learn a first task 556. In this example, knowledge data 520 acquired during the training of the first neural network 554 is stored and subsequently used, along with a smaller second dataset 562 relative to the second dataset 512 of FIG. 5A, to train a second neural network 564 to learn a second task 566. The knowledge data 520 may include learned weights, hyperparameters, and/or relevant input data, among other examples.

For instance, assume that the first task 556 and the second task 566 are associated with related domains. As such, rather than training the second neural network 564 with a relatively larger second dataset, the knowledge data 520 gained during training of the first neural network 554 can be leveraged to train the second neural network 564. For example, knowledge data gained during training of a first trained machine learning model 119 of FIG. 1 can be used, in some instances with additional system data, to train a second trained machine learning model 119.

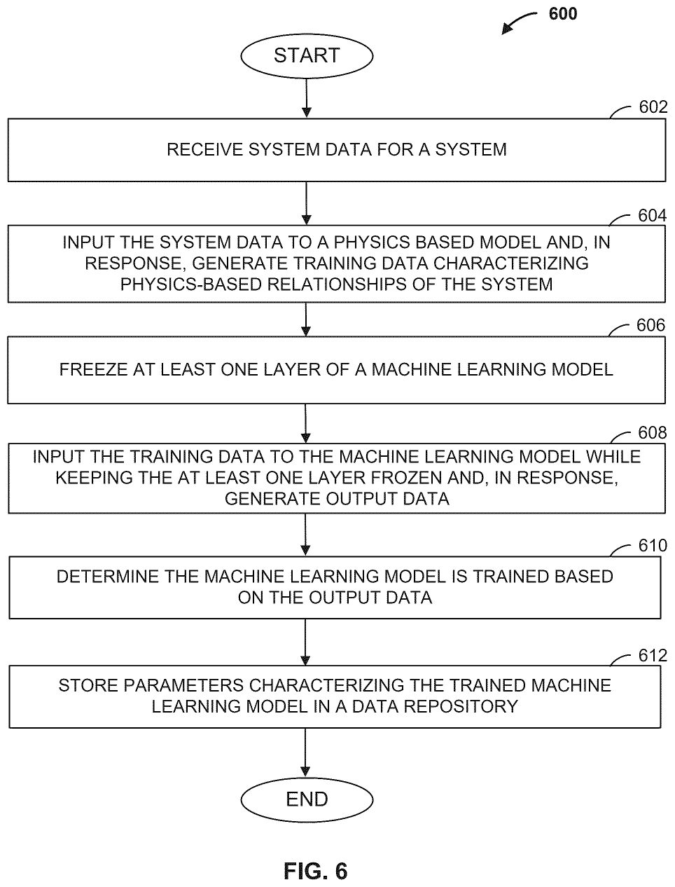

FIG. 6 is a flowchart of an example method 600 that can be carried out by one or more processors, such as by the MLSDP computing device 102 of FIG. 1. Beginning at block 602, system data (e.g., system data 301) for a system (e.g., system 104) is received. At block 604, the system data is input to a physics-based model and, in response, the physics-based model generates training data (e.g., physics-based system relationship data 303) characterizing physics-based relationships of the system.

Proceeding to block 606, at least one layer of a machine learning model is frozen. For instance, weights to all layers other than a last layer of a DeepOpNet (e.g., DeepOpNet 410) may be held constant. At block 608, the training data is input to the machine learning model while the at least one layer is kept frozen. In response, the machine learning model generates output data.

Further, at block 610, a determination is made, based on the output data, that the machine learning model is sufficiently trained. For example, as described herein, a metric value, such as a loss function, may be computed. The metric value may be compared to a threshold. If the metric value satisfies (e.g., exceeds, is less than) the threshold, the machine learning model is considered trained. Otherwise, if the metric value does not satisfy the threshold, the machine learning model continues to be trained with the same or additional training data.

When the machine learning model is trained, at block 612, parameters characterizing the trained machine learning model (e.g., trained machine learning model 119) is stored in a data repository (e.g., data repository 116).

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A computing device comprising at least one processor, wherein the at least one processor is configured to:
receive system data for a system;
input the system data to a physics-based model and, based on inputting the system data to the physics-based model, generate first output data characterizing physics-based relationships of the system;
input the first output data to a machine learning model and, based on inputting the first output data to the machine learning model, generate second output data;
determine, based on the second output data, that the machine learning model is trained; and
store parameters characterizing the trained machine learning model in a data repository.

2. The computing device of claim 1, wherein the machine learning model is a deep operator network.

3. The computing device of claim 2, wherein the deep operator network comprises a branch network and a trunk network, and wherein the at least one processor is configured to input a first portion of the training data to the branch network and a second portion of the training data to the trunk network.

4. The computing device of claim 1, wherein the machine learning model comprises a plurality of layers, and wherein the at least one processor is configured to hold constant weights for at least one of the plurality of layers while inputting the first output data to the machine learning model.

5. The computing device of claim 1, wherein the physics-based model is based on at least one mathematical relationship between characteristics of the system.

6. The computing device of claim 1, wherein machine learning model comprises at least a first weight for a first layer and a second weight for a second layer, wherein the inputted first output data causes the first weight to converge from a first value to a second value while maintaining the second weight at a third value.

7. The computing device of claim 1, wherein the system data comprises sensor data.

8. The computing device of claim 1, wherein the at least one processor is configured to transmit the second output data to a second computing device for display.

9. The computing device of claim 1, wherein the at least one processor is configured to:
receive the parameters from the data repository;
execute a trained machine learning model based on the parameters;
receive real-time system data from the system;
input the real-time system data to the trained machine learning model and, based on inputting the real-time system data to the trained machine learning model, generate third output data;
determine a status of the system based on the third output data; and
transmit status data characterizing the status of the system to a second computing device.

10. The computing device of claim 1, wherein the at least one processor is configured to:
determine, based on the second output data, at least one metric value;
compare the at least one metric value to a threshold; and
based on the comparison, determine the machine learning model is trained.

11. The computing device of claim 1, wherein the system is an engine.

12. The computing device of claim 11, wherein the system data comprises oil viscosity, engine operating temperature, and surface roughness of contacting bodies of the engine, and the second output data characterizes a severity of wear on the engine.

13. A method comprising:
receiving system data for a system;
inputting the system data to a physics-based model and, based on inputting the system data to the physics-based model, generating first output data characterizing physics-based relationships of the system;
inputting the first output data to a machine learning model and, based on inputting the first output data to the machine learning model, generating second output data;
determining, based on the second output data, that the machine learning model is trained; and
storing parameters characterizing the trained machine learning model in a data repository.

14. The method of claim 13, wherein the machine learning model is a deep operator network.

15. The method of claim 14, wherein the deep operator network comprises a branch network and a trunk network, and wherein the method comprises inputting a first portion of the training data to the branch network and a second portion of the training data to the trunk network.

16. The method of claim 13, wherein the machine learning model comprises a plurality of layers, and wherein the method comprises holding constant weights for at least one of the plurality of layers while inputting the first output data to the machine learning model.

17. The method of claim 13, wherein the physics-based model is based on at least one mathematical relationship between characteristics of the system.

18. A non-transitory computer readable medium having instructions stored thereon, wherein the instructions, when executed by at least one processor, cause the at least one processor to perform operations comprising:
receiving system data for a system;
inputting the system data to a physics-based model and, based on inputting the system data to the physics-based model, generate first output data characterizing physics-based relationships of the system;
inputting the first output data to a machine learning model and, based on inputting the first output data to the machine learning model, generate second output data;
determining, based on the second output data, that the machine learning model is trained; and
storing parameters characterizing the trained machine learning model in a data repository.

19. The non-transitory computer readable medium of claim 18, wherein the machine learning model is a deep operator network.

20. The non-transitory computer readable medium of claim 19, wherein the deep operator network comprises a branch network and a trunk network, and wherein the instructions, when executed by the at least one processor, further cause the at least one processor to perform operations comprising inputting a first portion of the training data to the branch network and a second portion of the training data to the trunk network.
